(19) United States
(12) Patent Application Publication
(10) Pub. No.: US 2026/0037309 A1
(43) Pub. Date: Feb. 5, 2026

(54) USER-FRIENDLY MODEL DEPLOYMENT FOR SECURE PROCESSING OF MACHINE LEARNING-BASED WORKLOADS

(71) Applicant: Palo Alto Networks, Inc., Santa Clara, CA (US)

(72) Inventors: Chiranjeevisantosh Madugundi, Santa Cruz, CA (US); Joseph Steve Louis, Woburn, MA (US); Dhanasekar Kandasamy, Chennai (IN); Santhosh Kumar Kuchoor, Dublin, CA (US); Ramesh Nampelly, Livermore, CA (US)

(21) Appl. No.: 18/788,661

(22) Filed: Jul. 30, 2024

(51) Int. Cl. G06F 9/50

(52) U.S. Cl. CPC G06F 9/5027

(57) ABSTRACT

A user-friendly platform provides a simplified procedure for end users to deploy models that utilize generative AI to perform tasks (hereinafter simply “AI model”) in a deployment environment (e.g. in a data center). Upon selection of an AI model to be deployed, the platform orchestrates deployment and allocation of resources that satisfy hardware requirements of the AI model. The platform includes an agent that communicates with infrastructure of the cloud provider or virtualization platform that manages deployed resources tracks allocation of hardware resources to virtual/cloud resources running on the deployment environment. The platform handles deployment of resources for deployment of the AI model “behind-the-scenes” from the user's perspective based on the monitored availability of hardware resources. For added security, the platform performs DLP scanning of data uploaded to the platform for input to an AI model that has been deployed.

### BACKGROUND

The disclosure generally relates to data processing (e.g., CPC subclass G06F) and to security arrangements for protecting computers, components thereof, programs, or data against unauthorized activity (e.g., CPC subclass G06F 21/00).

Cloud service providers/platforms (CSPs) provide cloud computing technology that delivers computing resources in the cloud. With cloud computing, applications and other computing resources traditionally hosted on-premises are delivered by a CSP over the Internet. End users of a CSP can interact with the CSP via application programming interfaces (APIs) of the CSP. Cloud APIs provide an interface for managing computing resources or utilizing the services of a CSP. In the context of cloud computing technology, “data center” refers to the physical location that hosts physical computing resources that support the provisioning and deployment of cloud-delivered computing resources.

The Stanford Institute for Human-Centered Artificial Intelligence created an interdisciplinary initiative named the Center for Research on Foundation Models. They coined the term “foundation models” to refer to machine learning models “trained on broad data at scale such that they can be adapted to a wide range of downstream tasks.” Some models considered foundation models include BERT, GPT-4, Codex, and LLAMA. Foundation models are based on artificial neural networks including generative adversarial networks (GANs), transformers, and variational encoders.

### BRIEF DESCRIPTION OF THE DRAWINGS

Embodiments of the disclosure may be better understood by referencing the accompanying drawings.

FIG. 1 is a conceptual diagram of orchestrating deployment of an AI model in a computing environment.

FIG. 2 is a flowchart of example operations for orchestrating deployment of a model that uses AI in a deployment environment.

FIG. 3 is a flowchart of example operations for determining one or more resources that should be deployed to satisfy hardware requirements of a model indicated for deployment.

FIG. 4 is a flowchart of example operations for determining hardware resource availability metrics for a deployment environment(s).

FIG. 5 depicts an example computer system with a model deployment manager and a resource allocation monitoring agent.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

This description uses shorthand terms related to cloud technology for efficiency and ease of explanation. When referring to “a cloud,” this description is referring to the resources of a CSP. For instance, a cloud can encompass the servers, virtual machines, and storage devices of a cloud service provider. In more general terms, a cloud resource accessible to customers is a resource owned/managed by the CSP entity that is accessible via network connections. Often, the access is in accordance with an API or software development kit (SDK) provided by the CSP.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Though generative artificial intelligence (AI) and the availability of LLMs and other foundation models has provided users with myriad capabilities, users may lack the knowledge of how to utilize these technologies. Additionally, the rise of use cases of these technologies for analyzing customer data has introduced new security concerns for organizations. To address these challenges, a user-friendly platform by which end users can deploy instances of models that utilize generative AI to perform tasks (hereinafter simply “AI model”) for secure use has been developed. Environments to which AI models can be deployed include data centers of an organization for which a cloud environment or virtualization platform provides and manages virtual resources (e.g., virtual machines) or other on-premises environments that are not publicly accessible. Thus, users (e.g., employees of an organization) can execute workloads with the AI models within the organization's own infrastructure rather than uploading data to infrastructure not owned or managed by the organization.

The platform also simplifies the procedure for deploying an AI model for users. Upon selection of an AI model to launch, the platform orchestrates deployment and allocation of virtual or cloud resources that satisfy hardware requirements of the AI model. Users thus can deploy AI models in a deployment environment (e.g., a cloud running on a data center) on demand without needing to also provision the resources that support execution of the AI models. The platform includes an agent that communicates with infrastructure of the cloud provider or virtualization platform that manages deployed resources tracks allocation of hardware resources to virtual/cloud resources in the deployment environment. The platform handles deployment of resources for deployment of the AI model “behind-the-scenes” from the user's perspective based on the monitored availability of hardware resources, which further reduces the knowledge required by the user for launching instances of AI models. For added security, the platform performs DLP scanning of data uploaded to the platform for input to an AI model that has been deployed. Data determined to be sensitive as a result of DLP scanning can be replaced with placeholder values before being input to the AI model.

### Example Illustrations

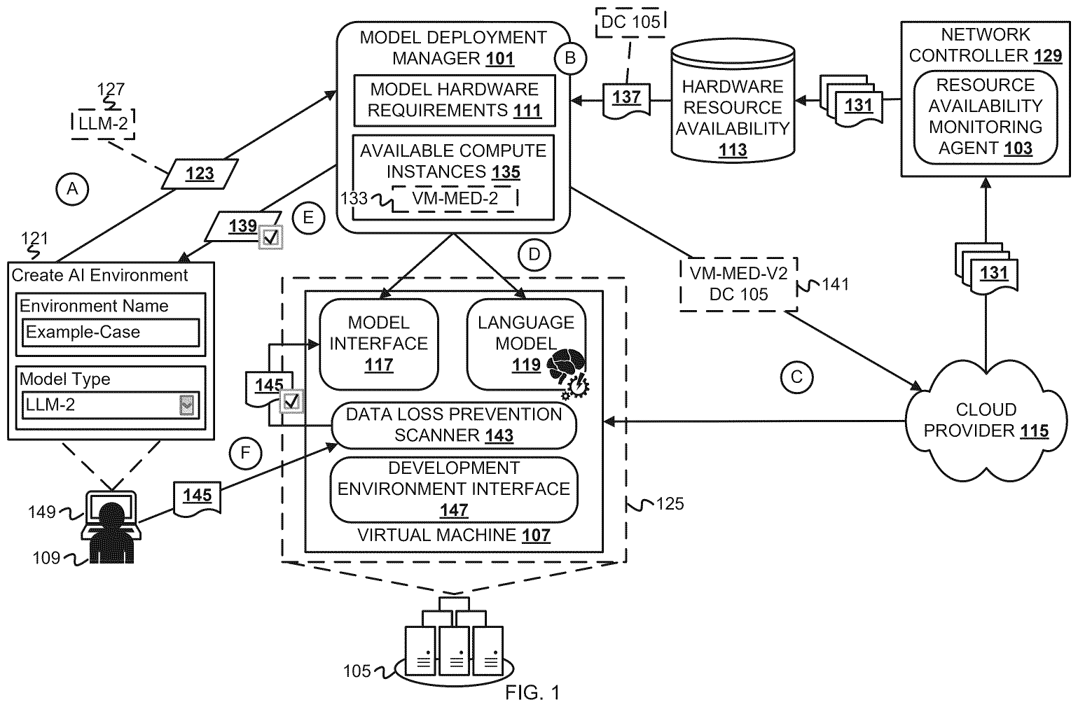

FIG. 1 is a conceptual diagram of orchestrating deployment of an AI model in a computing environment. A cloud provider 115 manages a deployment environment 125, which is a cloud environment, that runs on a data center 105. Figure I also depicts a model deployment manager (“deployment manager”) 101. The deployment manager 101 orchestrates deployment of AI models in various computing environments, such as various clouds running on different data centers of an organization. The deployment manager 101 can execute on a server, as a cloud-based service, or in a virtual machine provisioned in the data center 105, for instance. The deployment manager 101 can communicate with the cloud provider 115 (e.g., via an API of the cloud provider).

A resource availability monitoring agent (“monitoring agent”) 103 monitors allocation of resources within the data center 105. The monitoring agent 103 executes on a network controller 129 that communicates with a network device that has been distributed to the data center 105 (not depicted in FIG. 1). For instance, the network controller 129 may be a software-defined wide area network (SD-WAN) controller. While depicted as monitoring allocation of resources within the data center 105, the monitoring agent 103 can monitor allocation of resources across data centers, such as across data centers of a network (e.g., across data centers of an SD-WAN). The monitoring agent 103 periodically (e.g., every two hours) queries the cloud provider 115 for usage metrics of hardware resources in the data center 105. Hardware resources of the data center 105 differ from virtual or cloud resources of the data center 105 in that hardware resources refer to the physical hardware in the data center 105 from which virtual resources are allocated (e.g., virtual memory, virtual CPUs, virtual GPUs, etc.) by a hypervisor/virtual machine manager (VMM) of the data center 105. Hardware resource usage can include disk storage usage, memory usage, central processing unit (CPU) utilization, and/or graphics processing unit (GPU) utilization relative to hardware resource capacities of the data center 105. At each collection event, the monitoring agent 103 obtains hardware usage metrics (“usage metrics”) 135 from the cloud provider 115 and stores the usage metrics 131 in a data store 113 that maintains data indicating hardware resource availability. The usage metrics 135 indicate usage metrics of hardware resources by cloud resources for at least the data center 105.

FIG. 1 is annotated with a series of letters A-F. Each letter represents a stage of one or more operations. Although these stages are ordered for this example, the stages illustrate one example to aid in understanding this disclosure and should not be used to limit the claims. Subject matter falling within the scope of the claims can vary from what is illustrated. This example assumes that resources have not yet been deployed in the data center 105 at the beginning of stage A.

At stage A, a user 109 requests deployment of an AI model via a graphical user interface (GUI) 121 of an endpoint device 149. The user 109 in this example requests an AI model named “LLM-2” (“the requested AI model 127”). Implementations can support a variety of AI models which may or may not be pre-trained, such as pre-trained and/or open-source foundation models (e.g., language models such as LLMs). The user 109 selects this AI model type (e.g., from a drop down menu) and sends a request 123 to the deployment manager 101 via the endpoint device 149. Sending the request 123 can be based on a click event performed by the user 109 via the GUI 121. The request 123 identifies the requested AI model 127, or “LLM-2”.

At stage B, the deployment manager 101 determines a cloud resource(s) to deploy to satisfy hardware requirements of the requested AI model 127, which at least includes a computing instance (i.e., a virtual machine or container). The deployment manager 101 has been configured with model hardware requirements (“hardware requirements”) 111 for a plurality of supported AI models and available computing instances 135. The hardware requirements 111 indicate, for each supported AI model, requirements for memory capacity, disk storage capacity, CPU (e.g., number of cores and/or CPU type), and/or GPU (e.g., in terms of whether a GPU is required and optionally a video random access memory (VRAM) capacity).

The available computing instances 135 indicate types of virtual machines and/or containers offered by supported cloud providers and/or virtualization platforms and the specifications for each virtual machine and/or container type. Specifications of each compute instance can be represented with virtual and/or hardware resources, such as memory/storage capacities for virtual CPUs that correspond to physical CPU cores. The deployment manager 101 determines the smallest one of the available computing instances 135 that can support deployment of the requested AI model 127. A compute instance can support deployment of the requested AI model 127 if the hardware requirements of the requested AI model 127 are within the capacities of the compute instance. The deployment manager 101 selects a virtual machine type 133, named “VM-MED-2” as an example, from the available computing instances 135. This example assumes that the virtual machine type 133 is the smallest one of the available computing instances 135 that supports deployment of the requested AI model 127.

The deployment manager 101 also determines if there are sufficient hardware resources in the data center 105 to support deployment of the virtual machine type 133. The deployment manager 101 obtains hardware resource usage metrics 137 from the data store 113 (e.g., by performing a lookup in the data store 113 with an identifier of the data center 105) that indicate hardware resource availability for the data center 105. The deployment manager evaluates the specifications given for the virtual machine type 133 and the hardware resource usage metrics 137 of the data center 105 to determine if there are sufficient hardware resources available in the data center 105 for a virtual machine of the virtual machine type 133 to be deployed. There are sufficient hardware resources in the data center 105 if hardware resource capacities of the data center 105 will not be exceeded if the virtual machine is deployed. This example assumes that there are sufficient hardware resources in the data center 105 to support deployment of the virtual machine type 133.

At stage C, the deployment manager 101 deploys a virtual machine 107 in the data center 105. The deployment manager 101 communicates a request 141 to the cloud provider 115 (e.g., via the API of the cloud provider 115) to deploy a virtual machine of the designated type, or “VM-MED-V2”, in the data center 105. The cloud provider 115 in turn provisions a virtual machine 107 in the data center 105, where the virtual machine 107 is of the type determined by the deployment manager 101.

At stage D, the deployment manager 101 loads an instance of a language model 119, a model interface 117, and a development environment interface 147 into the virtual machine 107. The language model 119 corresponds to the requested AI model 127, or the language model named “LLM-2.” The deployment manager 101 can have access to a storage location that maintains an implementation of the language model 119 (e.g., a library), such as a repository that stores an open-source library(ies) by which the language model 119 is implemented. The deployment manager 101 orchestrates download and installation of the language model 119 in the virtual machine 107. The deployment manager 101 also deploys the model interface 117 to the virtual machine 107, where the model interface 117 comprises a chatbot interface by which the user 109 can submit task instructions to the language model 119. For instance, the model interface 117 can be implemented as an agent that communicates with the language model 119 via its API. The deployment manager 101 also orchestrates download and installation of the development environment interface 147 into the virtual machine 107. The development environment interface 147 provides a command line interface (CLI) and web interface by which the user 109 can create and run workloads. For instance, the development interface 147 can be the Jupyter® JupyterLab interface.

At stage E, the deployment manager 101 indicates to the user 109 that the language model 119 that was requested is available and ready for use. The deployment manager 101 communicates a notification 139 for presentation on the GUI 121 that indicates availability of the language model 119, successful deployment of the language model 119, etc. The user 109 can subsequently interact with the deployment environment interface 147 and/or model interface 117 via a CLI for submission of prompts and/or upload of data to be provided to the language model 119. For instance, the user 109 may access the deployment environment interface 147 via a web browser installed on the endpoint device 149 and/or CLI.

At stage F, a DLP scanner 143 scans an input 145 provided by the user 109 to the model interface 117 for processing with the language model 119. The DLP scanner 143 is instantiated in the deployment environment 125 (e.g., executes in its own container or virtual machine) and scans inputs provided by users to prevent unwanted exposure of sensitive data when such data is provided for processing. The input 145 can be data supplied by the user 109 for processing by the language model 119 and/or a prompt indicating a task instruction(s) to the language model 119. For the data included in the input 145 that the DLP scanner 143 determines to be sensitive, the DLP scanner 143 obfuscates the sensitive data, replaces the sensitive data with a generated replacement value, etc. The DLP scanner 143 provides the input 145 to the model interface 117 once it has been scanned and any sensitive data have been obfuscated or replaced.

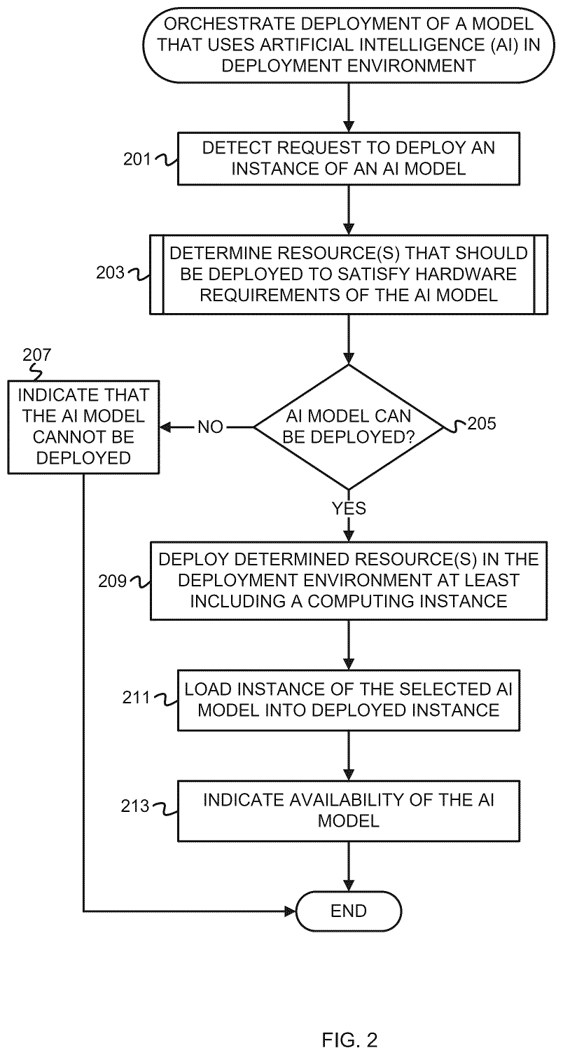

FIGS. 2-4 are flowcharts of example operations. The example operations are described with reference to a model deployment manager and a resource availability monitoring agent (hereinafter “the deployment manager” and “the monitoring agent”, respectively, for brevity) for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for orchestrating deployment of a model that uses AI in a computing environment. The computing environment is often a data center on which a cloud (e.g., a private cloud) or other virtual environment has been established. A cloud provider or virtualization platform manages resources that are allocated to the computing environment. The computing environment can expose an API (e.g., a cloud API) by which the deployment manager can modify existing resources or deploy new resources.

At block 201, the deployment manager detects a request to deploy an instance of an AI model. Detection of the request can be based on a click event initiated by a user, where the click event corresponds to a request to deploy an instance of the designated AI model. The AI model can be a pre-trained model and/or an open-source model, such as a pre-trained language model.

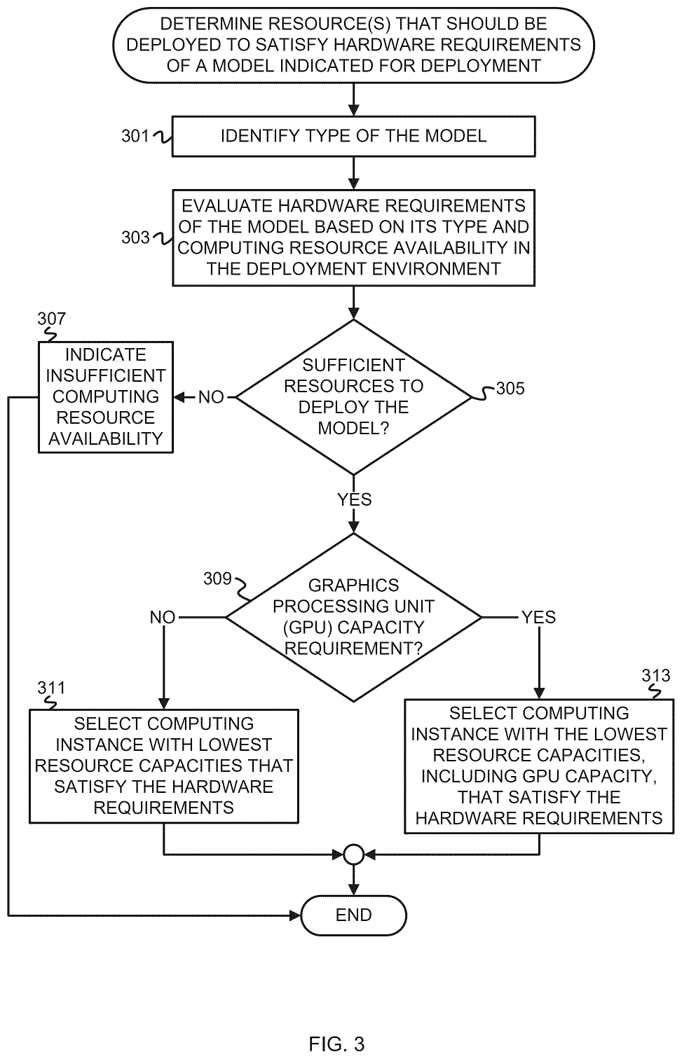

At block 203, the deployment manager determines one or more resources that should be deployed to satisfy hardware requirements of the AI model. The hardware requirements indicate memory, CPU, and any GPU requirements for running the AI model. The resource(s) to deploy at least includes a computing instance, which may be a container or virtual machine depending on resource offerings by the cloud provider or virtualization platform managing the computing environment. The computing instance has associated memory and CPU capacities and may further have a GPU capacity. The deployment manager determines the minimum resources that should be deployed to satisfy the hardware requirements of the AI model, such as the smallest virtual instance that supports the hardware requirements of the AI model. Determining resources to deploy to satisfy hardware requirements of the AI model is described in further detail in reference to FIG. 3.

At block 205, the deployment manager determines if the AI model can be deployed. The AI model may not be able to be deployed if there are insufficient resources available in the computing environment for execution of the AI model. In other words, the AI model cannot be deployed if the AI model requires more memory, CPUs, and/or GPUs than is available in the deployment environment. If the AI model cannot be deployed, operations continue at block 207. If the AI model can be deployed, operations continue at block 209.

At block 207, the deployment manager indicates that the AI model cannot be deployed. The deployment manager can generate a notification or alert (e.g., for presentation on a GUI) indicating that the AI model cannot currently be deployed. The deployment manager may suggest a more lightweight AI model(s) that can instead be deployed as an alternative.

At block 209, the deployment manager deploys the determined one or more resources in the computing environment, which at least includes a computing instance. The computing instance can be a virtual machine or container. The deployment manager communicates with a provider that manages resource deployment in the computing environment (e.g., via an API of the cloud provider or virtualization platform) to deploy the one or more resources, such as by submitting a request to deploy a resource(s) of an identified type(s). Virtual machines generally are associated with certain memory, CPU, and/or GPU capacities that are allocated to the virtual machine (e.g., by a virtual machine monitor (VMM)/hypervisor of the deployment environment) as virtual resources that map to corresponding hardware resources during deployment. For containers, the deployment manager can establish a CPU and/or GPU limit for the container based on the CPU and/or GPU specifications provided by the hardware requirements. The deployment manager can do so by invoking an API of the deployment environment to submit a request indicating the container and the CPU and/or GPU limit to enforce for the container. Deploying the determined resource(s) can also include orchestrating installment of software packages to the instance (i.e., the virtual machine or container) based on any software dependencies needed by the AI model.

At block 211, the deployment manager loads an instance of the selected AI model into the deployed instance. The deployment manager orchestrates download and installation of the AI model into the deployed instance (i.e., the container or virtual machine). For instance, the deployment manager can orchestrate download and installation of a library by which the AI model is implemented to the deployed instance. The deployment manager may have access to a repository or other location where the implementation of the AI model is maintained, such as an open-source repository.

At block 213, the deployment manager indicates availability of the AI model. The deployment manager can generate a notification (e.g., for presentation on a GUI) that indicates availability of the AI model to the user.

FIG. 3 is a flowchart of example operations for determining one or more virtual resources that should be deployed to satisfy hardware requirements of a model indicated for deployment. Virtual resources can include virtual machines, containers, and/or cloud-based resources. Different models have different hardware requirements, and different virtual resources offered for the deployment environment have different capacities for memory, CPUs, GPUs, etc. The deployment manager determines the virtual resource(s) to deploy that satisfies the hardware requirements of a designated model to alleviate the burden of evaluating hardware requirements and resource availability from the user requesting deployment of the model.

At block 301, the deployment manager identifies a type of the model. The type of the model is indicated in the request to deploy the model. The model may be a certain language model (e.g., an LLM) and version of that language model, such as a version number and number of parameters (e.g., Falcon-7B, Llama-2-7b, etc.). The deployment manager may be configured with a default model(s) that can be selected by end users rather than specifying a model type. In this case, the model type is the type of the selected default model.

At block 303, the deployment manager evaluates hardware requirements of the model based on its type and computing resource availability in the deployment environment. The deployment manager has been configured with indications of hardware requirements for the supported types of AI models (e.g., for the supported LLMs, smaller language models, or other foundation models) or obtains the hardware requirements from the cloud provider or virtualization platform (e.g., by submitting a request via an API of the cloud provider or virtualization platform). Hardware requirements can indicate requirements for memory capacity (e.g., in gigabytes (GB) of RAM), storage, CPU cores, and/or GPU capacity (e.g., in GB of video random access memory (VRAM)). The deployment manager also has access to computing resource availability in the deployment environment, which can be represented in terms of usage/availability of physical resources (i.e., hardware resources) or usage/availability of virtual resources that map to physical resources (e.g., virtual CPU usage). Since hardware resources may not have a one-to-one correspondence to virtual compute resources allocated in the deployment environment, such as may be the case with virtual CPUs and physical CPU cores, the deployment manager may also be configured with mappings between hardware resource capacities and virtual compute resource capacities for some resource types, such as CPUs, to inform resource availability.

At block 305, the deployment manager determines if there are sufficient computing resources to deploy the model. The deployment manager determines if there are sufficient hardware resources available in the deployment environment for allocation of virtual resources that support the indicated model. There are sufficient computing resources if the hardware requirements of the model for each computing resource type (i.e., RAM, CPU, storage, etc.) can be accommodated by the computing resource availability across computing resource types. If there are insufficient resources available, operations continue at block 307. If there are sufficient resources available, operations continue at block 309.

At block 307, the deployment manager indicates that there is insufficient computing resource availability. The deployment manager can generate a notification, alert, etc. indicating that there is not enough resource availability to allocate resources to the model.

At block 309, the deployment manager determines if there is a GPU capacity requirement for the model. Some models may be smaller and lightweight and thus can run without a GPU available, though larger models (e.g., some LLMs) may have a GPU capacity requirement indicated in their hardware requirements. The deployment manager determines if the hardware requirements indicate a GPU capacity requirement for the AI model. If there is not a GPU capacity requirement, operations continue at block 311. If there is a GPU capacity requirement, operations continue at block 313.

At block 311, the deployment manager selects a virtual instance with the lowest resource capacities that satisfy the hardware requirements. The deployment manager maintains indications of containers or virtual machines available for deployment in the deployment environment. Types of available containers or virtual machines can vary across deployment environments (e.g., across different cloud providers). The deployment manager determines the smallest container or virtual machine in terms of compute resource capacities that accommodates the hardware requirements of the model for each compute resource type. The containers or virtual machines that the deployment manager considers need not include containers or virtual machines with GPU capacities.

At block 313, the deployment manager selects a computing instance with the lowest resource capacities that include a GPU capacity and satisfy the hardware requirements. The deployment manager maintains indications of computing instances, which can include containers and/or virtual machines, available for deployment in the deployment environment. Types of available containers or virtual machines can vary across deployment environments (e.g., across different cloud providers). The deployment manager determines the smallest container or virtual machine in terms of compute resource capacities that accommodates the hardware requirements of the model for each compute resource type. The containers or virtual machines that the deployment manager considers include containers or virtual machines with GPU capacities.

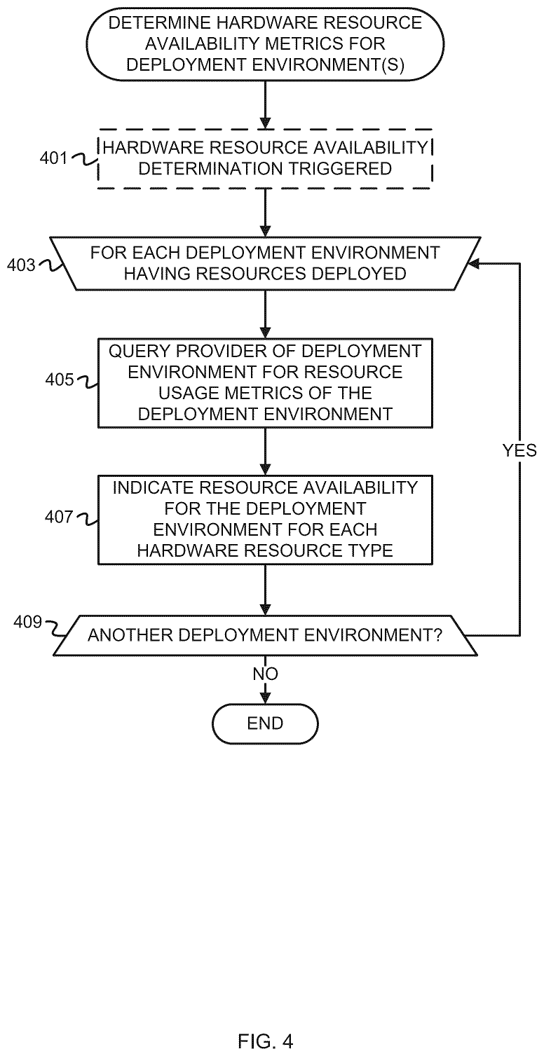

FIG. 4 is a flowchart of example operations for determining hardware resource availability metrics and deployment environment(s). The example operations are described with reference to the monitoring agent.

At block 401, resource availability determination is triggered. Block 401 is depicted with dashed lines since the trigger can be implicit, such as according to a schedule, or explicit, such as based on obtaining a request to determine resource availability.

At block 403, the monitoring agent begins iterating over deployment environments having resources deployed. Multiple deployment environments may be active for deployment of AI models as described above, such as multiple data centers of an organization for which the deployment environment provider (i.e., the cloud provider or virtualization platform) manages resource deployment. Different deployment environments may have different resources deployed as well as different hardware resource capacities.

At block 405, the monitoring agent queries the provider of the deployment environment for resource usage metrics of the deployment environment. The monitoring agent queries the provider of the deployment environment (e.g., via an API of the deployment environment) to request resource usage metrics for the deployment environment. The request can identify the deployment environment with a name, identifier, etc.

At block 407, the monitoring agent indicates resource availability for the deployment environment for each hardware resource type. The monitoring agent can store the resource availability metrics per resource type in a database or other data store with an indication of the deployment environment (e.g., a data center name or identifier) associated therewith. The database may be indexed by deployment environment indications to facilitate subsequent retrieval of resource availability metrics for the deployment environment. In implementations, the monitoring agent can tag the resource availability metrics per resource type with an indication(s) of the entity with which the usage metrics are associated, such as a department, user or group of users, etc., and indicate the entity(ies) associated with the usage metrics in the indicated resource availability. The usage metrics may thus be associated with an indication of an entity responsible for their accumulation to facilitate tracking resource usage across entities, such as across departments or groups.

At block 409, the monitoring agent determines if there is another deployment environment for which resource availability should be determined. If so, operations continue at block 403. Otherwise, operations are complete.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 403 through 409 of FIG. 4 can be performed at least partially in parallel or concurrently across deployment environments. For instance, the deployment manager can query the deployment environment provider for resource usage metrics of each deployment environment at once (e.g., in a single query indicating each deployment environment). It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

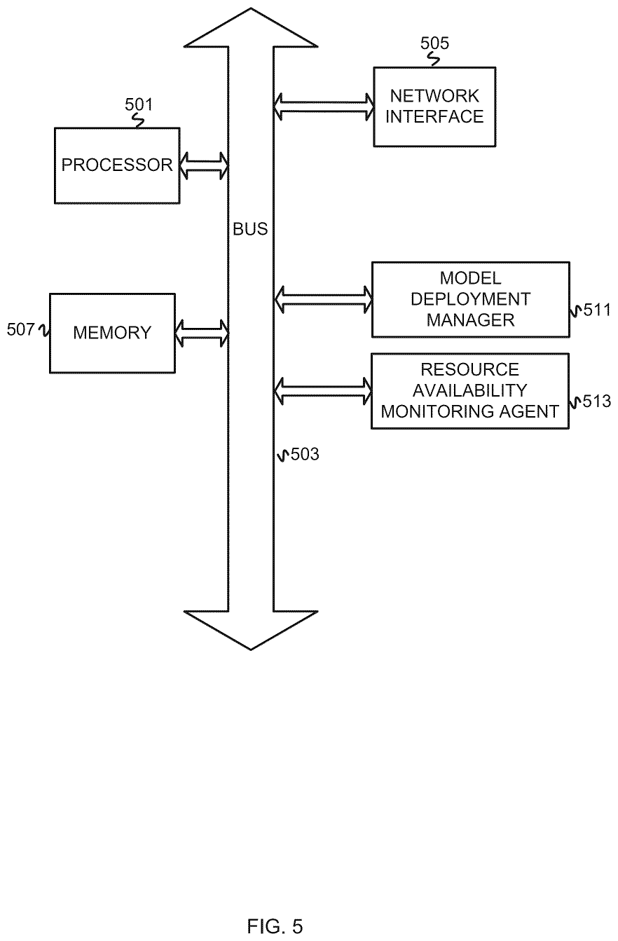

FIG. 5 depicts an example computer system with a model deployment manager and a resource allocation monitoring agent. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes model deployment manager 511 and resource availability monitoring agent (“monitoring agent”) 513. The model deployment manager 511 orchestrates deployment of an AI model selected by a user in a deployment environment, which includes deploying virtual resources based on hardware requirements of the AI model and availability of hardware resources in the deployment environment. The monitoring agent 513 determines availability of hardware resources in the deployment environment to inform resource deployment as part of orchestrating deployment of AI models. The model deployment manager 511 and monitoring agent 513 are depicted as part of the same example computer system of FIG. 5 to aid in understanding but do not necessarily execute as part of the same system. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

1. A method comprising:
in response to a click event in a user interface, deploying a first AI model in a first computing environment, wherein deploying the first AI model in the first computing environment comprises,
detecting a request to deploy the first AI model in the first computing environment, wherein the request identifies the first AI model;
deploying one or more resources in the first computing environment based on a type of the first AI model, wherein deploying the one or more resources comprises deploying a computing instance in the first computing environment, wherein the computing instance comprises a container or a virtual machine;
deploying an instance of the first AI model for execution in the first computing environment;
deploying an instance of an agent for execution in the computing instance, wherein the agent communicates with the first AI model; and
indicating availability of the first AI model.

2. The method of claim 1, wherein deploying the computing instance in the first computing environment comprises submitting a request for deployment of the computing instance based on invoking an application programming interface (API) of at least one of a cloud infrastructure platform and a virtualization platform that manages the first computing environment.

3. The method of claim 1, wherein the first computing environment is a cloud environment that runs on a data center.

4. The method of claim 1, further comprising determining, by a control plane agent, availability of hardware resources for allocation of corresponding virtual resources in the first computing environment.

5. The method of claim 4, further comprising determining the one or more virtual resources to deploy based on hardware requirements of the first AI model and the availability of hardware resources in the first computing environment.

6. The method of claim 5, wherein determining the one or more virtual resources based on the hardware requirements of the first AI model comprises determining that the hardware requirements indicate a graphics processing unit (GPU) requirement, and wherein deploying the one or more resources comprises selecting the computing instance for deployment based on a GPU capacity of the computing instance satisfying the GPU requirement of the first AI model and the availability of the hardware resources in the first computing environment.

7. The method of claim 1, wherein the agent comprises a chatbot interface and communicates with the first AI model via an API of the first AI model.

8. The method of claim 1, wherein the first AI model comprises at least one of an open-source model and a pre-trained language model.

9. The method of claim 1 further comprising, based on detecting upload of a dataset to the computing instance for input to the first AI model, designating the dataset for data loss prevention (DLP) scanning.

10. The method of claim 9 further comprising, based on determining that one or more values in the dataset comprise sensitive data, replacing each of the one or more values with a placeholder value before inputting the dataset into the first AI model.

11. One or more non-transitory machine-readable media having program code stored thereon, the program code comprising instructions to:
orchestrate deployment of a pre-trained model in a computing environment, wherein the instructions to orchestrate deployment of the pre-trained model comprise instructions to,
detect a request to deploy the pre-trained model in the computing environment, wherein the request identifies the pre-trained model;
deploy one or more resources in the computing environment based on a type of the pre-trained model, wherein the one or more resources at least comprise a computing instance, wherein the computing instance comprises a container or a virtual machine;
deploy an instance of the pre-trained model for execution in the computing environment;
deploy an agent to the computing instance, wherein the agent communicates with the pre-trained model; and
indicate availability of the pre-trained model.

12. The one or more non-transitory machine-readable media of claim 11, wherein the instructions to deploy the computing instance in the computing environment comprise instructions to submit a request for deployment of the computing instance based on invocation of an application programming interface (API) of at least one of a cloud infrastructure platform and a virtualization platform that manages the computing environment.

13. The one or more non-transitory machine-readable media of claim 11, wherein the program code further comprises instructions to,
determine, by a control plane agent, availability of hardware resources for allocation of corresponding virtual resources in the computing environment; and
determine the one or more virtual resources to deploy based on hardware requirements of the pre-trained model and the availability of the hardware resources in the computing environment.

14. The one or more non-transitory machine-readable media of claim 11, wherein the agent comprises a chatbot interface and communicates with the pre-trained model via an application programming interface (API) of the pre-trained model.

15. An apparatus comprising:
a processor; and
a machine-readable medium having instructions stored thereon that are executable by the processor to cause the apparatus to,
orchestrate deployment of a first artificial intelligence (AI) model in a first computing environment, wherein the instructions to orchestrate deployment of the first AI model comprise instructions to,
detect a request to deploy the first artificial intelligence (AI) model in the first computing environment, wherein the request identifies the first AI model;
deploy one or more virtual or cloud resources in the first computing environment based on a type of the first AI model, wherein the one or more virtual or cloud resources comprise a container or a virtual machine;
deploy an instance of the first AI model for execution in the first computing environment, wherein the first AI model has been pre-trained;
deploy an instance of an agent for execution in the container or virtual machine, wherein the agent communicates with the first AI model; and
indicate availability of the first AI model.

16. The apparatus of claim 15, wherein the instructions executable by the processor to cause the apparatus to deploy the one or more virtual or cloud resources in the first computing environment comprise instructions to submit a request for deployment of the one or more virtual or cloud resources based on invocation of an application programming interface (API) of at least one of a cloud infrastructure platform and a virtualization platform that manages the first computing environment.

17. The apparatus of claim 15, further comprising instructions executable by the processor to cause the apparatus to,
determine, by a control plane agent, availability of hardware resources for allocation of corresponding virtual resources in the first computing environment; and
determine the one or more virtual resources to deploy based on hardware requirements of the first AI model and the availability of the hardware resources in the first computing environment.

18. The apparatus of claim 17, wherein the instructions executable by the processor to cause the apparatus to determine the one or more virtual or cloud resources based on the hardware requirements of the first AI model comprise instructions executable by the processor to cause the apparatus to determine one of a plurality of virtual or cloud resources to deploy based on the hardware requirements of the first AI model, computing resource capacities of each of the plurality of virtual or cloud resources, and the availability of hardware resources in the first computing environment.

19. The apparatus of claim 15, further comprising instructions executable by the processor to cause the apparatus to, based on detection of upload of a dataset to the container or virtual machine for input to the first AI model, designate the dataset for data loss prevention (DLP) scanning.

20. The apparatus of claim 15, wherein the agent comprises a chatbot interface and communicates with the first AI model via an API of the first AI model, and wherein the first AI model comprises at least one of an open-source model and a pre-trained language model.
